(19) United States
(12) Patent Application Publication
(10) Pub. No.: US 2004/0156761 A1
(43) Pub. Date: Aug. 12, 2004

(54) Honeycomb assembly having a honeycomb body with an expansion-compensating mounting, especially for an exhaust-gas catalytic converter

(76) Inventors: Rolf Bruck, Bergisch Gladbach (DE); Jorg-Roman Konieczny, Siegburg (DE); Lorenzo Pace, Lohmar-Heide (DE); Jan Hodgson, Neunkirchen-Seelscheid (DE)

Correspondence Address: LERNER AND GREENBERG, P.A., POST OFFICE BOX 2480, HOLLYWOOD, FL, 33022-2480, US

(21) Appl. No.: 10/770,761

(22) Filed: Feb. 2, 2004

Related U.S. Application Data
(63) Continuation of application No. PCT/EP02/08283, filed on Jul. 25, 2002.

(30) Foreign Application Priority Data
Aug. 2, 2001 (DE) 101 37 878.5

(51) Int. Cl. B01D 53/34; B32B 3/12

(52) U.S. Cl. 422/179; 428/116; 422/177; 422/180

(57) ABSTRACT

A honeycomb assembly includes a honeycomb body which is held in a housing and has an outer surface, especially in an exhaust gas system of an internal combustion engine. The honeycomb body has an axial length and the outer surface is surrounded by at least one metal sheet which is bent in sections into a plurality of layers that can move radially towards each other between the outer surface and the housing, forming overhanging bulges of the metal sheet in circumferential direction. The bulges extend forwards and backwards in the circumferential direction. The honeycomb body held in the housing can expand thermally in an almost unimpeded manner relative to the housing, so that a durable fixation of the honeycomb body in the housing, especially in the housing of an exhaust gas system of an internal combustion engine, can be obtained. The assembly is particularly useful for honeycomb bodies with a high channel density of 800 cpsi and a sheet metal thickness of less than 0.025 mm.

### CROSS-REFERENCE TO RELATED APPLICATION

This application is a continuation of copending International Application No. PCT/EP02/08283, filed Jul. 25, 2002, which designated the United States.

### BACKGROUND OF THE INVENTION

Field of the Invention

The invention relates to a honeycomb assembly having a honeycomb body held in a housing with an expansion-compensating mounting, especially for an exhaust-gas catalytic converter.

Such a honeycomb body is described in German Published, Non-prosecuted Patent Application DE 39 30 680 A1. In that case, the honeycomb body, together with a metallic housing, forms the core piece of a catalytic converter for purifying exhaust gases from internal combustion engines. Due to the temperature gradients and the mechanical loads which occur in an exhaust system, the honeycomb body is not brazed to the housing over the entire periphery, but rather is elastically attached to the housing by two or more bearings or mountings. That holding configuration with a plurality of lateral rings or segments, a multiplicity of leaf springs, at least one slip ring and seals for the annular gap, requires a high outlay in terms of production and assembly, so that the holding configuration is able to withstand the thermal and dynamic loads in an exhaust system.

The invention is based on German Patent DE 38 17 490 C2, which describes a honeycomb body having a corrugated strip that surrounds it and is provided with corrugations which are asymmetric and inclined in one direction. In that way relative movements between the honeycomb body and the housing can be absorbed by the corrugations yielding and by the honeycomb body rotating in the housing.

### SUMMARY OF THE INVENTION

It is accordingly an object of the invention to provide a honeycomb assembly having a honeycomb body with an expansion-compensating mounting, especially for an exhaust-gas catalytic converter, which overcomes the hereinafore-mentioned disadvantages of the heretofore-known devices of this general type and which provides a holding configuration for a honeycomb body secured in a housing that is simple to produce and ensures a durable connection that is able to withstand high loads, between the honeycomb body and the housing, even in the event of extreme thermal and dynamic conditions in the exhaust system.

With the foregoing and other objects in view there is provided, in accordance with the invention, a honeycomb assembly, in particular in an exhaust system of an internal combustion engine. The honeycomb assembly comprises a housing and a honeycomb body held in the housing and having an outer surface and an axial length. At least one metal sheet surrounds the outer surface and is bent in sections into a plurality of layers being movable in radial direction relative to one another between the outer surface and the housing. The bending of the at least one metal sheet forms bulges overhanging in circumferential direction. The bulges extend forward and backward in circumferential direction. The honeycomb body holding configuration according to the invention is used in particular to fix a honeycomb body in a housing of an exhaust system of an internal combustion engine.

The bending of the metal sheet, in sections, to form a plurality of layers which can move in the radial direction with respect to one another between the outer surface and the housing, means that the metal sheet advantageously acquires the function of a sprung, flexible holding configuration, so that relative movements between the outer surface and the housing can be tolerated without problems within a wide range.

It is advantageous if the bulges extend forward and backward in the circumferential direction, since in this way any torsion of the honeycomb body relative to the housing as a result of relative expansions is avoided, and thereby low-frequency natural frequencies of the oscillating honeycomb body/housing system, which could lead to resonant peaks and therefore to increased wear, are alleviated.

Furthermore, it is advantageous to use the extent of the bulge in the circumferential direction of the metal sheet to reduce the heat transfer from the honeycomb body to the housing. In this way, in particular in the cold-starting phase of the operating temperature of the catalytic converter, the catalytic conversion of pollutants is reached more quickly.

In accordance with another feature of the invention, the bulges in the metal sheet, which each extend individually in one direction in the circumferential direction, alternately extend forward and backward in the circumferential direction. This bending profile suppresses torsion of the honeycomb body relative to the housing.

In accordance with a further feature of the invention, each individual bulge extends forward and backward in the circumferential direction.

In accordance with an added feature of the invention, it is advantageous to alter the bending profile along the axial direction of the honeycomb body. This allows the rigidity with which the honeycomb body is secured to the housing to be influenced in a controlled way along the axial direction of the honeycomb body, so that regions of the honeycomb body of relatively high rigidity and regions of a lower rigidity can be predetermined.

In accordance with an additional feature of the invention, at least two metal sheets are spaced apart behind one another in the axial direction. In each case the sheets are bent in sections into a plurality of layers that can move in the radial direction with respect to one another, between the outer surface and the housing, so that the bending forms bulges in the sheet-metal layers, which overhang in the circumferential direction, in such a way that the bulges extend forward and backward in the circumferential direction. This configuration reduces the conduction of heat between the honeycomb body and the housing due to the reduction in the cross-sectional area which is available for the heat conduction. Therefore, in return, the honeycomb body can be heated more quickly to the required operating temperature.

In accordance with yet another feature of the invention, at least two metal sheets, which have in each case been bent in sections into a plurality of layers, that can move in the radial direction with respect to one another, between the outer surface and the housing, are spaced apart behind one another in the circumferential direction. With the aid of this configuration, the thermal contact between the honeycomb body and the housing through heat conduction is reduced further.

In accordance with yet a further feature of the invention, connecting sections on that side of the metal sheet which is directed toward the outer surface are connected to the outer surface by joining and/or connecting sections on the side directed toward the housing are connected to the housing by technical joining. This connection by technical joining results in permanent fixing of the honeycomb body on the housing.

In accordance with a concomitant feature of the invention, the sheet-metal layers are constructed in meandering form, in particular in the form of an omega. The wide overhang results in an advantageous elasticity of the structure combined with good heat-insulating properties.

Other features which are considered as characteristic for the invention are set forth in the appended claims.

Although the invention is illustrated and described herein as embodied in a honeycomb assembly having a honeycomb body with an expansion-compensating mounting, especially for an exhaust-gas catalytic converter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a honeycomb body held in a housing;

FIGS. 2 to 5 are enlarged, fragmentary, cross-sectional views of various configurations of bulges in sheet-metal layers;

FIG. 6 is a perspective view of a honeycomb body which is held in a housing and has a bulge profile that varies along the axial direction;

FIG. 7 is an end-elevational view of a honeycomb body which is held in a housing and has an outer surface that is surrounded by four metal sheets;

FIGS. 8A-8C are three fragmentary, cross-sectional views as seen in the axial direction along the honeycomb body held in a housing; and

FIGS. 9 to 12 are fragmentary, cross-sectional views of further configurations of bulges in the sheet-metal layers.

### DESCRIPTION OF THE PREFERRED EMBODIMENTS

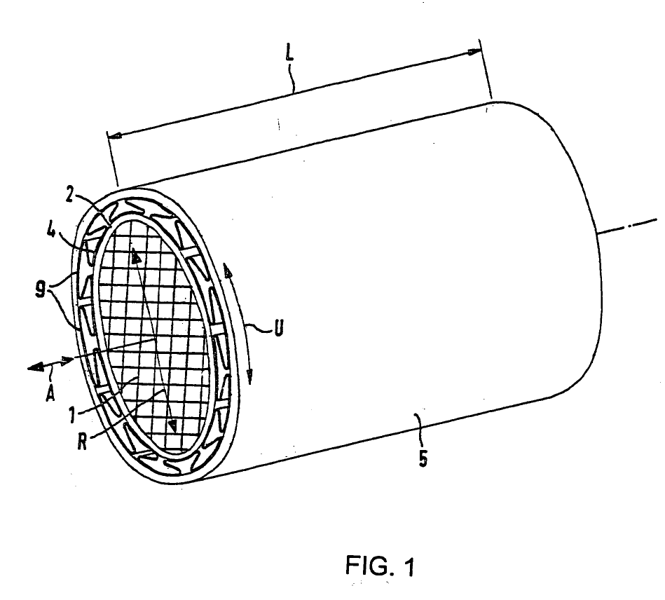

Referring now to the figures of the drawings in detail and first, particularly, to FIG. 1 thereof, there is seen a honeycomb body 1 which is held in a housing 5 and has an outer surface 2 and an axial length L. The outer or jacket surface 2 is surrounded by a metal sheet 4 which, in sections, is bent into a plurality of layers. The layers can move in the radial direction R with respect to one another, between the outer surface 2 and the housing 5. The bending carried out on the structure 9 of the metal sheet 4 leads to bulges (indicated by reference numeral 3 in subsequent figures), which overhang or project in the circumferential direction U, being formed in the sheet-metal layers. These bulges extend forward and backward as seen in the circumferential direction. The bending carried out on the metal sheet 4 causes the metal sheet 4 to acquire a resilient property, so that relative movement between the honeycomb body 1 and the housing 5 can be absorbed or damped. The metal sheet 4 is, in sections, connected to the outer surface 2 by technical joining at an inner side thereof directed toward the outer surface 2 and/or connected to the housing 5 by technical joining at an outer side thereof directed toward the housing 5. Therefore, if the thickness of the metal sheet 4 is selected appropriately, the connection by technical joining is protected, by virtue of the elasticity of the structure, from being torn out or becoming worn as a result of vibrations and/or expansions on the part of the honeycomb body 1 with respect to the housing 5. The structure combines an elastic attachment with a permanent form of securing. Furthermore, the structure results in an increased thermal insulation, since on one hand the heat conduction in the metal sheet 4 is reduced due to the longer sheet-metal distance which has to be overcome, and on the other hand the thermal radiation, which with black body radiation is proportional to the fourth power of the temperature, is effectively reduced by temperature stages induced by the sheet-metal layers. The rigidity of the structure can be adjusted inter alia by the height of the structure in relation to its width or the width of the overhang, by the number of bulges 3, the number of folds within a bulge 3 or the selected sheet-metal thickness.

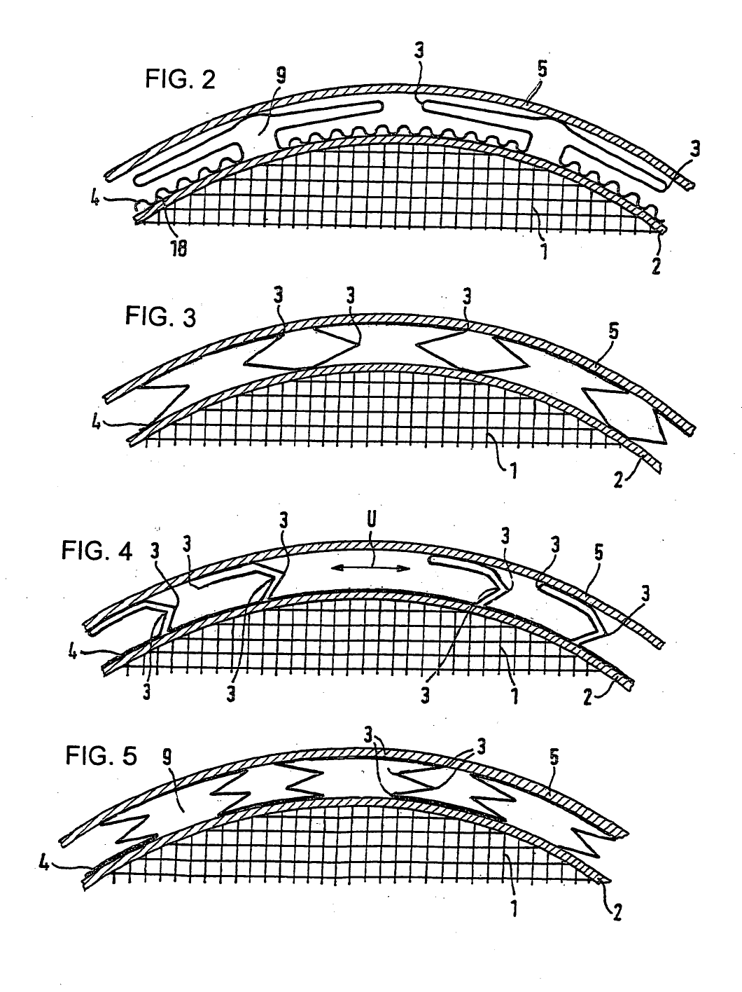

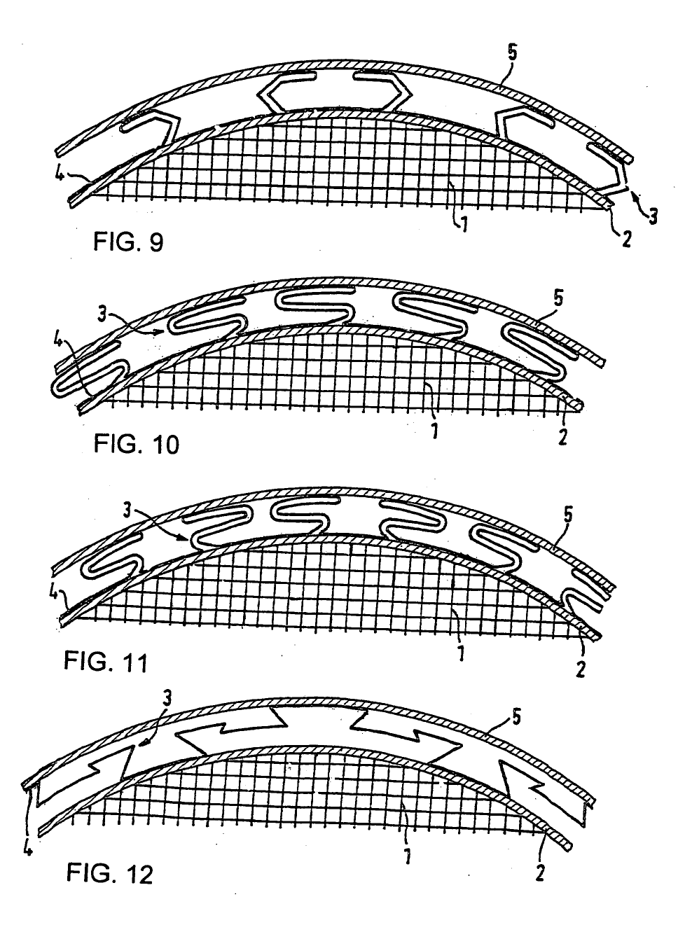

FIGS. 2 to 5 and FIGS. 9 to 12 show different configurations of the bulges 3 in the metal sheet 4 in the form of a fragmentary view of a cross section through a honeycomb body 1 held in a housing 5. It is very clearly apparent from the figures what is meant by overhanging bulges 3. In FIG. 2, the bulges 3 are broader at their upper side than at their base, so that the upper side, as seen in the radial direction, extends beyond the base of the bulge 3 in both the forward and the backward direction. The metal sheet 4 is wound in a meandering form around the outer surface 2 and forms an omega-like structure 18. There is an overhang on both the right-hand side and the left-hand side of the bulge. The bulges 3 in FIGS. 2, 3, 5 and 10 to 12 in each case extend individually forward and backward as seen in the circumferential direction. In FIGS. 4 and 9, a single bulge extends either forward or backward in the circumferential direction, but overall the bulges 3 face both forward and backward, since some bulges 3 are directed forward, as seen in the circumferential direction, while others are directed backward, as seen in the circumferential direction. The fact that the bulges extend forward and backward in the circumferential direction, whether this is true of a single bulge 3 or of the bulges 3 taken as a whole, reduces rotation of the honeycomb body 1 relative to the housing 5 in the event of thermal expansion or vibration, or indeed prevents the same if an exactly symmetrical structure is used. Alternatively, the number of bulges 3 extending forward in the circumferential direction may differ from the number of bulges extending backward in the circumferential direction. In this case, a rotation of the honeycomb body 1 relative to the housing 5 is to be expected.

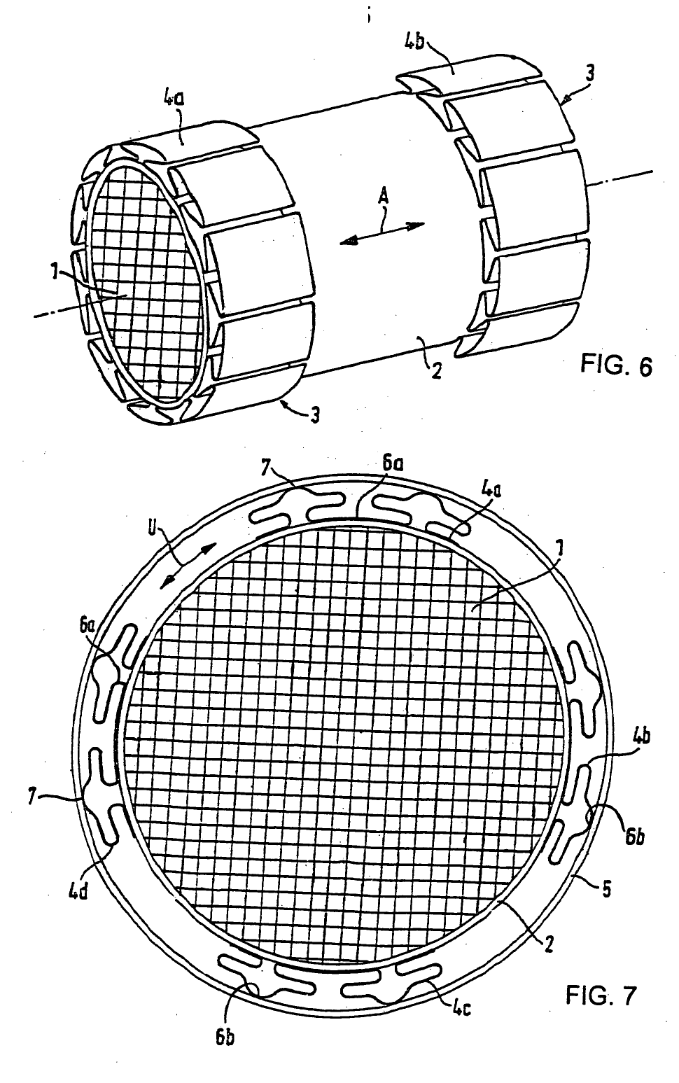

FIG. 6 shows a honeycomb body 1 having an outer surface 2 around which two metal sheets 4a, 4b, that are spaced apart in the axial direction A, have been wound. These metal sheets 4a, 4b in turn have been converted in sections, by bending, into a plurality of layers which can move in the radial direction with respect to one another between the outer surface 2 and the non-illustrated housing 5. The bending forms bulges 3, which overhang in the circumferential direction, in the sheet-metal layers. The bulges 3 extend forward and backward in the circumferential direction. This has the advantage of interrupting heat transfer resulting from heat conduction from the honeycomb body 1 to the housing 5.

FIG. 7 shows a honeycomb body 1 having an outer surface 2 which is surrounded by four metal sheets 4a, 4b, 4c, 4d that are spaced apart behind one another as seen in the circumferential direction. In this case too, the heat transfer resulting from heat conduction from the honeycomb body 1 to the housing 5 is reduced. Inner connecting sections 6a on the inner side of the metal sheet 4 which is directed toward the outer surface 2 are connected to the outer surface 2 by technical joining and/or outer connecting sections 6b on the outer side of the metal sheet 4 which is directed toward the housing 5 are connected to the housing 5 by technical joining. Brazing processes have proven to be a suitable technique for connecting by technical joining. However, a sintering process or even welding may be used as well.

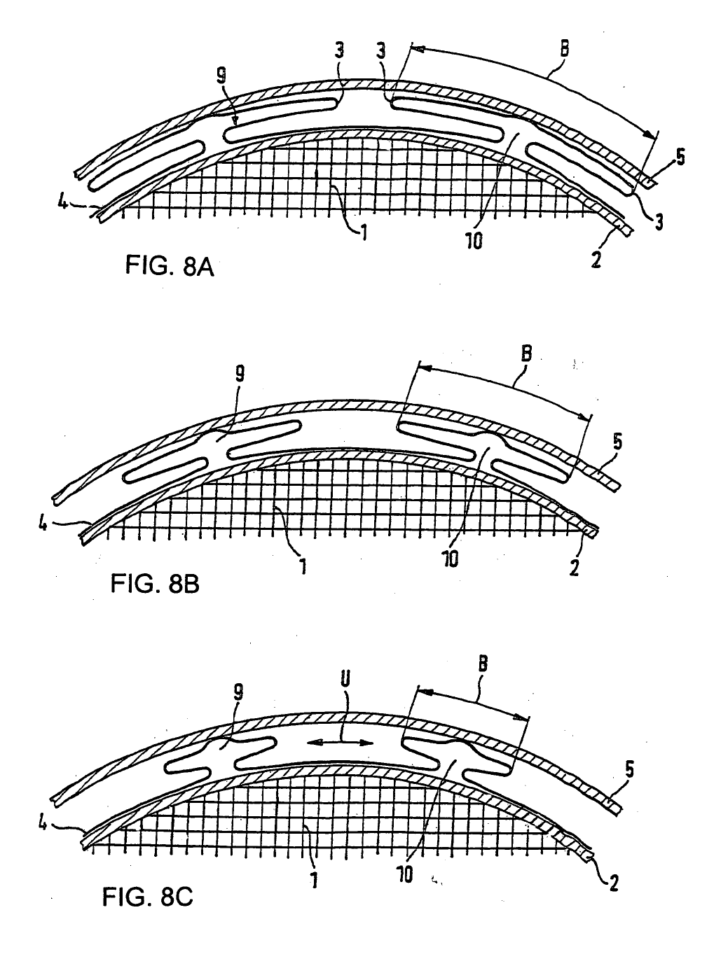

FIG. 8A, FIG. 8B and FIG. 8C show a configuration of the bulges 3 formed by a structure 9, 10 of the surrounding metal sheet 4 in which the bulge profile changes along the axial direction of the honeycomb body 1. These figures illustrate three cross sections through the honeycomb body 1 at different locations along the axial direction of the honeycomb body 1. As can be seen, the width B of the overhang in the bulge 3 in FIG. 8A is particularly pronounced, decreases in FIG. 8B and has only a weak presence in FIG. 8C. The reduction in the overhang of the bulge 3 results in a modified elastic behavior leading to an increase in the stiffness with which the honeycomb body 1 is held on the housing 5 by the metal sheet 4 as the overhang increases. A structure of the bulges 3 which has been modified in this way along the axial direction (the modification does not have to increase or decrease continuously, but rather may in very general terms be produced by any desired function) allows the elastic character of the way in which the honeycomb body 1 is held in the housing 5 to be tailored to the particular requirements.

The bulges 3 illustrated in the drawings merely represent a few selected realizations from a wide range of bulges 3 and are not to be interpreted as restricting the invention.

The honeycomb body held in a housing in accordance with the invention can expand virtually unimpeded with respect to the housing, yet durable fixing of the honeycomb body in the housing, in particular in the housing of an exhaust system of an internal combustion engine, is still ensured. Furthermore, a high degree of thermal decoupling between honeycomb body and housing is achieved.

We claim:

1. A honeycomb assembly, comprising:
a housing;
a honeycomb body held in said housing and having an outer surface and an axial length;
at least one metal sheet surrounding said outer surface and being bent in sections into a plurality of layers being movable in radial direction relative to one another between said outer surface and said housing; and
said at least one bent metal sheet having bulges overhanging in circumferential direction, said bulges extending forward and backward in circumferential direction.

2. The honeycomb assembly according to claim 1, wherein said bulges in said at least one metal sheet each extend individually in one direction in circumferential direction and alternately extend forward and backward in circumferential direction.

3. The honeycomb assembly according to claim 1, wherein said bulges individually extend forward and backward in circumferential direction.

4. The honeycomb assembly according to claim 1, wherein said bulges each have a bulge profile changing along axial direction of said honeycomb body.

5. The honeycomb assembly according to claim 1, wherein said at least one metal sheet is at least two metal sheets spaced apart one behind the other in axial direction and surrounding said outer surface.

6. The honeycomb assembly according to claim 1, wherein said at least one metal sheet is at least two metal sheets spaced apart one behind the other in circumferential direction and surrounding said outer surface.

7. The honeycomb assembly according to claim 1, wherein said at least one metal sheet has an inner side facing toward said outer surface, an outer side facing toward said housing, inner connecting sections connecting said inner side to said outer surface by technical joining, and outer connecting sections connecting said outer side to said housing by technical joining.

8. The honeycomb assembly according to claim 1, wherein said at least one sheet-metal layer is wound in a meandering shape around said outer surface.

9. The honeycomb assembly according to claim 8, wherein said meandering shape is an omega shape.

10. An exhaust system of an internal combustion engine, comprising:
a housing;
a honeycomb body held in said housing for conducting exhaust gas of the internal combustion engine, said honeycomb body having an outer surface and an axial length;
at least one metal sheet surrounding said outer surface and being bent in sections into a plurality of layers being movable in radial direction relative to one another between said outer surface and said housing; and
said at least one bent metal sheet having bulges overhanging in circumferential direction, said bulges extending forward and backward in circumferential direction.
